(19) United States
(12) Patent Application Publication
(10) Pub. No.: US 2024/0199001 A1
(43) Pub. Date: Jun. 20, 2024

(54) AUTOMOBILES

(71) Applicant: TOYOTA JIDOSHA KABUSHIKI KAISHA, Toyota-shi (JP)

(72) Inventor: Akira HOJO, Susono-shi (JP)

(73) Assignee: TOYOTA JIDOSHA KABUSHIKI KAISHA, Toyota-shi (JP)

(21) Appl. No.: 18/454,317

(22) Filed: Aug. 23, 2023

(30) Foreign Application Priority Data
Dec. 15, 2022 (JP) 2022-199905

(51) Int. Cl. B60W 20/16; B60W 10/06; B60W 10/08; B60W 20/30

(52) U.S. Cl. CPC B60W 20/16; B60W 10/06; B60W 10/08; B60W 20/30; B60W 10/11; B60W 2710/0694; B60W 2710/086

(57) ABSTRACT

An automobile includes an engine having a catalyst device incorporating a catalyst for reducing exhaust gas in an exhaust system and having an in-cylinder injection valve, an automatic transmission for shifting power from the engine and outputting the power to a drive wheel side, and a control device for performing catalyst warm-up control for warming up the catalyst by performing multi-stage injection for performing a plurality of fuel injections from the in-cylinder injection valve and a retard angle of an ignition timing. The control device executes the load factor increase control so that the required load factor to the engine becomes equal to or higher than the multi-stage injection realization load factor capable of realizing the multi-stage injection during the catalyst warm-up control.

### CROSS-REFERENCE TO RELATED APPLICATION

This application claims priority to Japanese Patent Application No. 2022-199905 filed on Dec. 15, 2022, incorporated herein by reference in its entirety.

### BACKGROUND

### 1. Technical Field

The present disclosure relates to an automobile, and particularly, to an automobile including an engine having an in-cylinder injection valve and an automatic transmission.

### 2. Description of Related Art

Conventionally, as an automobile of this type, a fuel injection valve that injects fuel directly into a cylinder of an engine is proposed (for example, refer to Japanese Unexamined Patent Application Publication No. 2001-041089 (JP 2001-041089A)). In this automobile, when the engine is operated at a high load, the number of injections of fuel injection is increased as compared with when the engine is operated at a low load, thereby suppressing deterioration in emission.

### SUMMARY

Generally, immediately after the engine is started, a catalyst warm-up operation is performed in order to activate a catalyst of a purifying device attached to an exhaust system of the engine. At this time, it is preferable to perform multi-stage injection in which the engine is subjected to a certain load operation and fuel is injected from an in-cylinder injection valve in a plurality of times in order to promote the catalyst warm-up. In an automobile including an automatic transmission that transmits power from an engine to a drive wheel by changing the speed of the power, if an operation region of the engine becomes a deceleration region or a light load region in accordance with a change in vehicle speed, the multi-stage injection cannot be performed, and emission during catalyst warm-up may deteriorate.

A main object of an automobile of the present disclosure is to suppress deterioration of emission during catalyst warm-up.

The automobile of the present disclosure adopts the following means in order to achieve the above-described main object.

An automobile of the present disclosure, includes: an engine that includes a catalyst device incorporating a catalyst for reducing exhaust gas in an exhaust system, and an in-cylinder injection valve; an automatic transmission that changes a speed of power from the engine and outputs the power to a drive wheel side; and a control device that performs a catalyst warm-up control for warming up the catalyst by performing a multi-stage injection and retarding an ignition timing, the multi-stage injection being a plurality of fuel injections from the in-cylinder injection valve. The control device executes a load factor increase control such that a required load factor of the engine becomes equal to or higher than a multi-stage injection realization load factor at which the multi-stage injection is enabled during the catalyst warm-up control.

In the automobile of the present disclosure, the control device performs the catalyst warm-up control for warming up the catalyst in the catalyst device attached to the exhaust system of the engine by performing the multi-stage injection that is a plurality of fuel injections from the in-cylinder injection valve and by retarding the ignition timing. Further, the control device executes the load factor increase control such that the required load factor of the engine becomes equal to or higher than the multi-stage injection realization load factor at which the multi-stage injection is enabled during the catalyst warm-up control. Thus, the required load factor of the engine becomes equal to or higher than the multi-stage injection realization load factor, the catalyst warm-up by the multi-stage injection can be continued, and the deterioration of the emission can be suppressed as compared with the case where the catalyst warm-up by the multi-stage injection cannot be continued.

In the automobile of the present disclosure, the load factor increase control may be a control of increasing the required load factor by decreasing a rotational speed of the engine by upshifting a gear range of the automatic transmission.

As a result, it is possible to suppress the emission from deteriorating as the required load factor of the engine is equal to or higher than the multi-stage injection realization load factor.

In the automobile of the present disclosure, the automobile may further include: an electric motor that allows power to be input to and output from an input shaft or an output shaft of the automatic transmission; and a power storage device that exchanges electric power with the electric motor.

The load factor increase control may be a control of increasing the required load factor by controlling the electric motor.

In this case, the load factor increase control may be a control of increasing the required load factor by reducing a power running output of the electric motor when the electric motor is under a power running control, and increasing the required load factor by regeneratively controlling the electric motor when the electric motor is not under the power running control. In this way, it is possible to suppress the emission from deteriorating as the required load factor of the engine is equal to or higher than the multi-stage injection realization load factor without changing the gear range of the automatic transmission. Further, in this case, the load factor increase control may be a control of increasing the required load factor by regeneratively controlling the electric motor when the electric motor is not under the power running control and a power storage ratio of the power storage device is less than a predetermined ratio, and increasing the required load factor by decreasing a rotational speed of the engine by upshifting a gear range of the automatic transmission when the electric motor is not under the power running control and the power storage ratio of the power storage device is equal to or higher than the predetermined ratio. In this way, even when the power storage ratio of the power storage device is equal to or higher than the predetermined ratio, the required load factor of the engine is increased by the upshifting to be equal to or higher than the multi-stage injection realization load factor, so that it is possible to suppress the deterioration of emission.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a configuration diagram schematically illustrating a configuration of a hybrid electric vehicle 20 according to an embodiment of the present disclosure;

FIG. 2 is a configuration diagram illustrating an outline of a configuration of an engine 22 mounted on a hybrid electric vehicle 20;

FIG. 3 is an explanatory diagram illustrating an exemplary relation between engine-load factor KL and emission by one injection and a multi-stage injection;

FIG. 4 is a flow chart illustrating an exemplary catalytic warm-up load factor changing process performed by the engine ECU 24; and

FIG. 5 is a chart illustrating an exemplary load factor increase control executed by engine ECU 24.

### DETAILED DESCRIPTION OF EMBODIMENTS

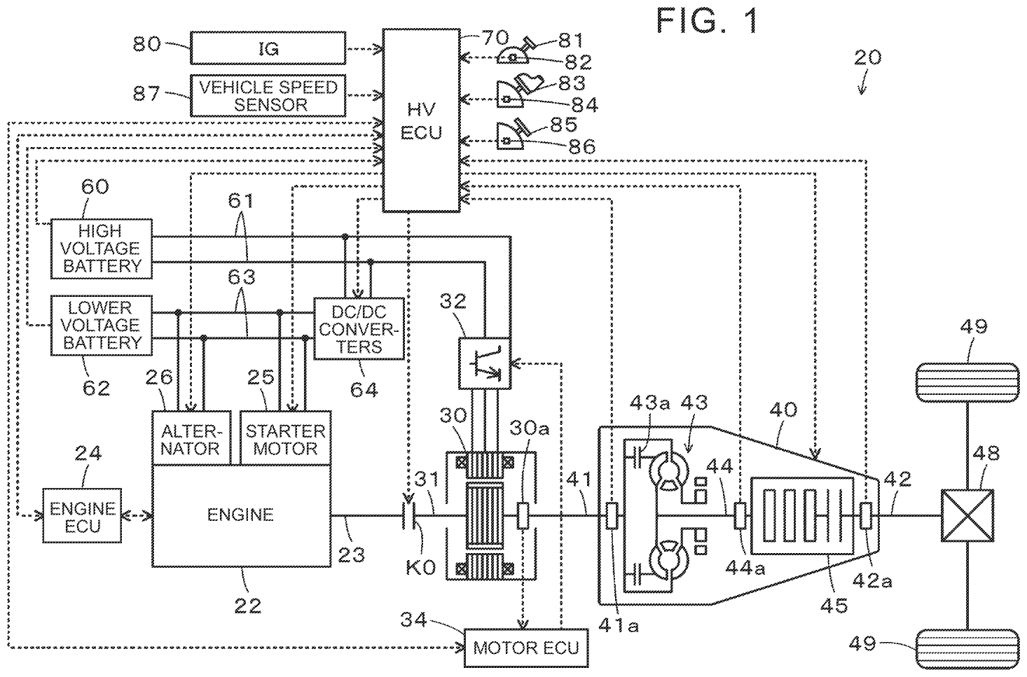

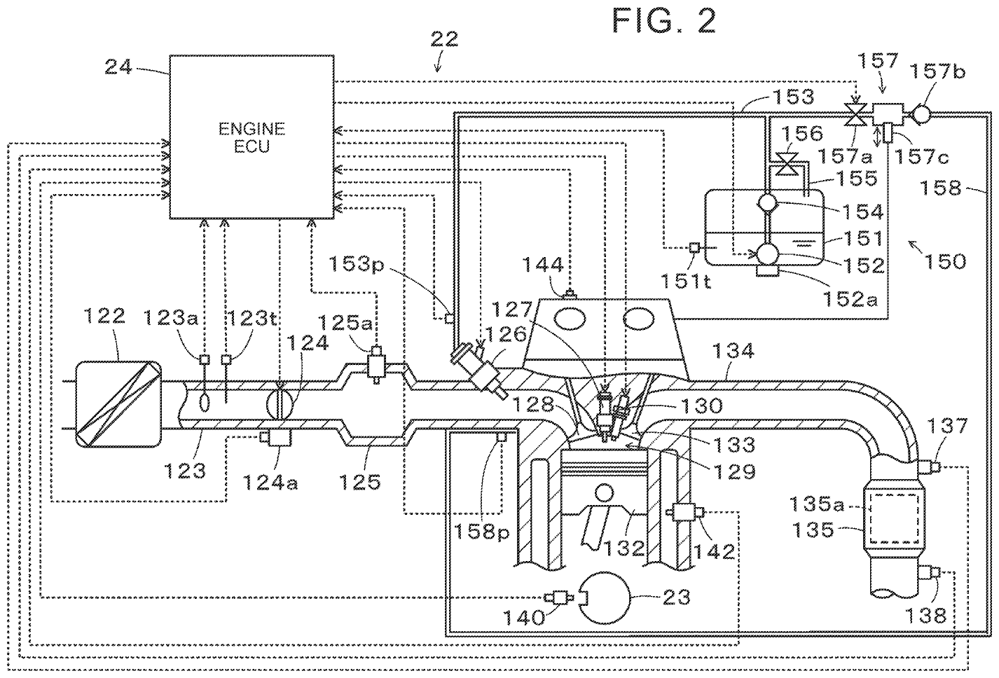

Next, an embodiment for carrying out the present disclosure will be described. FIG. 1 is a configuration diagram schematically illustrating a configuration of a hybrid electric vehicle 20 according to an embodiment of the present disclosure. FIG. 2 is a configuration diagram illustrating an outline of a configuration of the engine 22 mounted on hybrid electric vehicle 20. As shown in FIG. 1, hybrid electric vehicle 20 of the embodiment includes an engine 22, a motor 30, an inverter 32, a clutch K0, an automatic transmission 40, a high-voltage battery 60, a low-voltage battery 62, a DC/DC converter 64, and a hybrid-use electronic control unit (hereinafter referred to as “HVECU”) 70.

The engine 22 is configured as a six-cylinder internal combustion engine that outputs power by four strokes of intake, compression, expansion (explosion combustion), and exhaust using fuel such as gasoline and gas oil. As illustrated in FIG. 2, the engine 22 includes a port injection valve 126 that injects fuel supplied from the fuel supply device 150 to the intake port via the low-pressure supply pipe 153, and an in-cylinder injection valve 127 that injects fuel supplied from the fuel supply device 150 into the cylinder via the high-pressure supply pipe 158. The in-cylinder injection valve 127 is disposed substantially in the center of the top portion of the combustion chamber 129, and injects fuel in a spray shape. The spark plug 130 is disposed in the vicinity of the in-cylinder injection valve 127 so as to be able to ignite the fuel sprayed from the in-cylinder injection valve 127 in a spray shape. The engine 22 includes the port injection valve 126 and the in-cylinder injection valve 127, and thus can operate in any one of the port injection mode, the in-cylinder injection mode, and the shared injection mode. In the port injection mode, the air cleaned by the air cleaner 122 is sucked into the intake pipe 123 to pass through the throttle valve 124 and the surge tank 125, and the fuel is injected from the port injection valve 126 on the downstream side of the surge tank 125 of the intake pipe 123 to mix the air and the fuel. Then, the air-fuel mixture is sucked into the combustion chamber 129 via the intake valve 128, and is exploded and burned by an electric spark generated by the spark plug 130, and the reciprocating motion of the piston 132, which is depressed by the energy in the cylinder bore, is converted into the rotational motion of the crankshaft 23. In the in-cylinder injection mode, similarly to the port injection mode, air is sucked into the combustion chamber 129, fuel is injected from the in-cylinder injection valve 127 in an intake stroke or a compression stroke, and is explosively burned by an electric spark by the spark plug 130 to obtain a rotational motion of the crankshaft 23. In the shared injection mode, fuel is injected from the port injection valve 126 when air is sucked into the combustion chamber 129, and fuel is injected from the in-cylinder injection valve 127 in an intake stroke or a compression stroke, and is explosively burned by an electric spark by the spark plug 130 to obtain a rotational motion of the crankshaft 23. These injection modes are switched based on the operating state of the engine 22. The exhaust gas discharged from the combustion chamber 129 to the exhaust pipe 134 via the exhaust valve 133 is discharged to the outside air via the purifying device 135. The purifying device 135 includes a purifying catalyst (three-way catalyst) 135a for purifying harmful components of carbon monoxide (CO), hydrocarbons (HC), and nitrogen oxides (NOx) in the exhaust gas.

The fuel supply device 150 is configured as a device that supplies the fuel in the fuel tank 151 to the port injection valve 126 and the in-cylinder injection valve 127 of the engine 22. The fuel supply device 150 includes a fuel tank 151, a feed pump 152, a low-pressure supply pipe 153, a check valve 154, a relief pipe 155, a relief valve 156, a high-pressure pump 157, and a high-pressure supply pipe 158.

The feed pump 152 is disposed in the fuel tank 151, and supplies the fuel in the fuel tank 151 to the low-pressure supply pipe 153. The low-pressure supply pipe 153 is connected to the port injection valve 126. The check valve 154 is provided in the low-pressure supply pipe 153 to allow the flow of fuel in the direction from the feed pump 152 side toward the port injection valve 126 side and to restrict the flow of fuel in the reverse direction.

The relief pipe 155 is connected to the low-pressure supply pipe 153 and the fuel tank 151. The relief valve 156 is provided in the relief pipe 155, and closes when the fuel pressure in the low-pressure supply pipe 153 is less than the threshold Pflolim, and opens when the fuel pressure in the low-pressure supply pipe 153 is equal to or greater than the threshold Pflolim. When the relief valve 156 is opened, a portion of the fuel in the low-pressure supply pipe 153 is returned to the fuel tank 151 via the relief pipe 155.

The high-pressure pump 157 is configured as a pump that is driven by power from the engine 22 (in the embodiment, rotation of an intake camshaft that opens and closes the intake valve 128) and pressurizes the fuel in the low-pressure supply pipe 153 to be supplied to the high-pressure supply pipe 158. The high-pressure pump 157 has a solenoid valve 157a which is connected to the suction port and opens and closes when pressurizing the fuel, a check valve 157b which is connected to the discharge port and regulates the reverse flow of the fuel and holds the fuel pressure in the high-pressure supply pipe 158, and a plunger 157c which is operated (vertically moved in FIG. 1) by the rotation of the engine 22 (rotation of the intake camshaft). During operation of the engine 22, the high-pressure pump 157 sucks the fuel in the low-pressure supply pipe 153 when the solenoid valve 157a is opened, and intermittently feeds the fuel compressed by the plunger 157c to the high-pressure supply pipe 158 through the check valve 157b when the solenoid valve 157a is closed, thereby pressurizing the fuel supplied to the high-pressure supply pipe 158.

The operation of the engine 22 is controlled by an engine ECU 24 configured as a microcomputer. The engine ECU 24 receives signals from various sensors required to control the operation of the engine 22 through input ports. For example, the crank angle θcr from the crank position sensor 140 that detects the rotational position of the crankshaft 23 of the engine 22, the cooling coolant temperature Tw from the water temperature sensor 142 that detects the temperature of the coolant of the engine 22, the rotational position of the intake camshaft that opens and closes the intake valve 128, and the cam angles θci and θco from the cam position sensor 144 that detects the rotational position of the exhaust camshaft that opens and closes the exhaust valve 133 can be cited. The throttle opening degree TH from the throttle valve position sensor 124a for detecting the position of the throttle valve 124, the intake air amount Qa from the air flow meter 123a mounted on the upstream side of the throttle valve 124 of the intake pipe 123, the intake air temperature Ta from the temperature sensor 123t mounted on the upstream side of the throttle valve 124 of the intake pipe 123, and the surge pressure Ps from the pressure sensor 125a mounted on the surge tank 125 can also be mentioned. The front air-fuel ratio AF1 from the front air-fuel ratio sensor 137 mounted upstream of the purifying device 135 in the exhaust pipe 134 and the rear air-fuel ratio AF2 from the rear air-fuel ratio sensor 138 mounted between the purifying device 135 and PM filters 136 in the exhaust pipe 134 can also be cited. The fuel temperature Tftnk from the fuel temperature sensor 151t attached to the fuel tank 151, the rotational speed Np of the feed pump 152 from the rotational speed sensor 152a attached to the feed pump 152, the low-pressure fuel pressure PL from the fuel pressure sensor 153p, and the high-pressure fuel pressure PH from the fuel pressure sensor 158p can also be mentioned.

Various control signals for controlling the operation of the engine 22 are output from the engine ECU 24 via the output port. Examples of the signal outputted from the engine ECU 24 include a control signal to the throttle valve 124, a control signal to the port injection valve 126, a control signal to the in-cylinder injection valve 127, and a control signal to the spark plug 130. Control signals to the feed pump 152 of the fuel supply device 150 and control signals to the solenoid valve 157a of the high-pressure pump 157 may also be mentioned.

The engine ECU 24 is connected to the HVECU 70 via a communication port. The engine ECU 24 calculates the rotational speed Ne of the engine 22 based on the crank angle θcr of the engine 22 from the crank position sensor 140. Further, the engine ECU 24 calculates a post-start integrated air amount ΣQa which is an integrated value from the start of the intake air amount Qa from the air flow meter 123a, and calculates a load factor (a ratio of a volume of air actually sucked in one cycle to a stroke volume per cycle of the engine 22) KL based on the intake air amount Qa and the rotational speed Ne of the engine 22.

As shown in FIG. 1, a starter motor 25 for cranking the engine 22 and an alternator 26 for generating electric power using power from the engine 22 are connected to the crankshaft 23 of the engine 22. The starter motor 25 and the alternator 26 are connected to the low-voltage-side power lines 63 together with the low-voltage battery 62 and are controlled by HVECU 70.

The motor 30 is configured as a synchronous generator motor. The rotational shaft 31 to which the rotor of the motor 30 is fixed is connected to the crankshaft 23 of the engine 22 via a clutch K0 and is connected to the input shaft 41 of the automatic transmission 45. The inverter 32 is used to drive the motor 30 and is connected to the high-voltage-side power lines 61. The motor 30 is rotationally driven by switching control of a plurality of switching elements of the inverter 32 by a motor electronic control unit (hereinafter referred to as “motor ECU”) 34.

The motor ECU 34 is configured to receive a signal from various sensors via an input port. For example, the rotational position Om from the rotational position sensor 30a that detects the rotational position of the rotor (rotational shaft 31) of the motor 30 and the phase current Iu, Iv from the current sensor that detects the phase current of each phase of the motor 30 can be cited. In the motor ECU 34, a control signal to the inverter 32 and the like are output via an output port. The motor ECU 34 is connected to HVECU 70 via a communication port. The motor ECU 34 calculates the rotational speed Nm of the motor 30 based on the rotational position Om of the rotor (rotational shaft 31) of the motor 30 from the rotational position sensor 30a.

The clutch K0 is configured as, for example, a hydraulic-driven frictional clutch, and is controlled by a HVECU 70 to connect and disconnect the crankshaft 23 of the engine 22 and the rotational shaft 31 of the motor 30.

The automatic transmission 40 includes a torque converter 43 and, for example, a six-stage automatic transmission 45. The torque converter 43 is configured as a general fluid transmission device, and transmits the power of the input shaft 41 connected to the rotational shaft 31 of the motor 30 to the transmission input shaft 44 that is the input shaft of the automatic transmission 45 by amplifying the torque, or transmits the torque without amplifying the torque. The automatic transmission 45 includes a transmission input shaft 44, an output shaft 42 connected to the drive wheels 49 via a differential gear 48, a plurality of planetary gears, and a plurality of friction engagement elements (clutches and brakes) for hydraulic driving. The automatic transmission 45 forms a forward stage or a reverse stage from the first speed to the sixth speed by disengagement of a plurality of friction engagement elements, and transmits power between the transmission input shaft 44 and the output shaft 42. Hydraulic pressure of hydraulic oil from a mechanical oil pump or an electric oil pump is regulated and supplied to the clutch K0 or the automatic transmission 45 by a hydraulic control device (not shown). The hydraulic control device is controlled by a HVECU 70.

The high-voltage battery 60 is configured as, for example, a lithium-ion secondary battery or a nickel-hydrogen secondary battery having a rated voltage of about several hundred volts, and is connected to the high-voltage-side power lines 61 together with the inverter 32. The low-voltage battery 62 is configured as, for example, a lead-acid battery having a rated voltage of about 12 V or 14 V, and is connected to the low-voltage-side power lines 63 together with the starter motor 25 and the alternator 26. DC/DC converter 64 is connected to the high-voltage-side power lines 61 and the low-voltage-side power lines 63. DC/DC converter 64 supplies the power of the high-voltage-side power lines 61 to the low-voltage-side power lines 63 with a voltage step-down.

HVECU 70 receives signals from various sensors via an input port. For example, the rotational speed Nin from the rotational speed sensor 41a attached to the input shaft 41 of the automatic transmission 40, the rotational speed Nmi from the rotational speed sensor 44a attached to the transmission input shaft 44 of the automatic transmission 40, and the rotational speed Nout from the rotational speed sensor 42a attached to the output shaft 42 of the automatic transmission 40 can be cited. Mention may also be made of the voltage Vbh of the high-voltage battery 60 from a voltage sensor mounted between terminals of the high-voltage battery 60, the current Ibh of the high-voltage battery 60 from a current sensor mounted at an output terminal of the high-voltage battery 60, and the voltage Vbl of the low-voltage battery 62. Examples thereof include an ignition signal from the ignition switch 80, a shift position SP from the shift position sensor 82 that detects an operating position of the shift lever 81, an accelerator operation amount Acc from the accelerator pedal position sensor 84 that detects a depression amount of the accelerator pedal 83, a brake pedal position BP from the brake pedal position sensor 86 that detects a depression amount of the brake pedal 85, and a vehicle speed V from the vehicle speed sensor 87.

HVECU 70 outputs various control signals via an output port. For example, a control signal to the starter motor 25, a control signal to the alternator 26, a control signal to the clutch K0 or the automatic transmission 40 (hydraulic control device), and a control signal to DC/DC converter 64 may be mentioned. HVECU 70 is connected to an engine ECU 24 or a motor ECU 34 via a communication port. HVECU 70 calculates input/output limits Win, Wout as an allowable maximum power that can be input/output to/from the power storage ratio SOC of the high-voltage battery 60 and the high-voltage battery 60 based on the voltage Vbh and the current Ib of the high-voltage battery 60.

In hybrid electric vehicle 20 of the embodiment configured as described above, the engine 22, the clutch K0, the motor 30, and the automatic transmission 40 are controlled so as to travel in the hybrid travel mode (HV travel mode) or the electric travel mode (EV travel mode) by the cooperative control of HVECU 70, the engine ECU 24, and the motor ECU 34.

In the control of the engine 22 and the motor 30 in HV traveling mode, HVECU 70 first sets a required torque Tout* (required for the output shaft 42 of the automatic transmission 40) required for traveling based on the accelerator operation amount Acc and the vehicle speed V. Subsequently, a value obtained by dividing the required torque Tout* of the output shaft 42 by the rotational speed specific Gt of the automatic transmission 40 is set to the required torque Tin* of the input shaft 41. Then, the target torque Te* of the engine 22 and the torque command Tm* of the motor 30 are set so that the required torque Tin* is outputted to the input shaft 41, and the target torque Te* is transmitted to the engine ECU 24 and the torque command Tm* is transmitted to the motor ECU 34. The engine ECU 24 calculates the required load factor KL* from the target torque Te*, and performs operation control (intake air amount control, fuel injection control, ignition control, and the like) of the engine 22 so that the engine 22 is operated at the target torque Te*. The motor ECU 34 performs switching control of the plurality of switching elements of the inverter 32 so that the motor 30 is driven by the torque command Tm*.

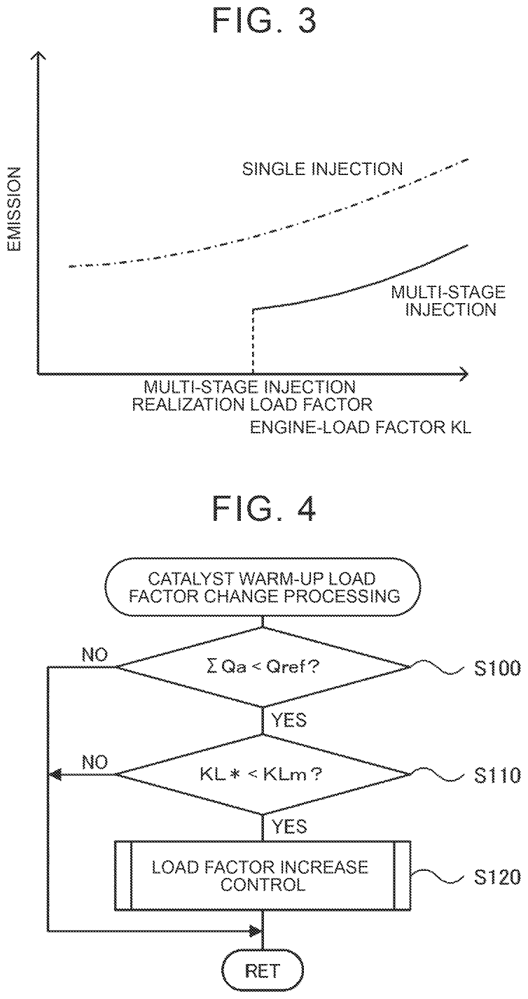

Next, the operation of hybrid electric vehicle 20 of the embodiment thus configured, in particular, the operation during the catalyst warm-up control for warming up the purifying catalyst 135a in the purifying device 135 will be described. Catalyst warm-up is performed by multi-stage injection in which fuel is injected in a plurality of times from the in-cylinder injection valve 127 to the intake stroke to the expansion stroke, as compared with the case of single injection in which fuel is injected only once from the in-cylinder injection valve 127 in the intake stroke or the compression stroke, as shown in FIG. 3, since the emission is good, in the embodiment, by multi-stage injection. FIG. 3 is an explanatory diagram illustrating an exemplary relation between the engine-load factor KL and the emission by the single injection and the multi-stage injection. In the figure, a solid line indicates a multi-stage injection, and a dashed-dotted line indicates a single injection. Note that, in the multi-stage injection, since the minimum injection amount of one injection is determined depending on the number of injections, the load factor KL needs to be equal to or higher than the minimum load factor (multi-stage injection realization load factor KLm) capable of realizing the multi-stage injection.

FIG. 4 is a flow chart illustrating an exemplary catalytic warm-up load factor changing process performed by the engine ECU 24. This process is repeatedly executed while the catalyst warm-up control is being executed. When the catalytic warm-up load factor changing process is executed, the engine ECU 24 first determines whether or not the post-start integrated air amount ΣQa, which is the integrated value of the intake air amount Qa from the start of the engine 22 to the present, is less than the threshold Qref (S100). The threshold-value Qref may be a predetermined value as the cumulative air-volume required for the catalyst-warming-up to be completed to some extent. When it is determined that the accumulated air amount ΣQa after starting is equal to or greater than the threshold Qref, it is determined that the catalytic warm-up is completed to some extent and that the emission is not deteriorated, and the process is ended.

When it is determined in S100 that the post-start accumulated air amount ΣQa is less than the threshold Qref, it is determined whether or not the required load factor KL* of the engine 22 is less than the multi-stage injection realization load factor KLm (S110). The required load factor KL* of the engine 22 is calculated as the load factor KL required for outputting the target torque Te* at the rotational speed Ne at that time. The multi-stage injection realization load factor KLm can be obtained as a lower limit of a load factor KL capable of realizing multi-stage injection in which fuel is injected from the in-cylinder injection valve 127 in a plurality of times. When it is determined that the required load factor KL* of the engine 22 is equal to or greater than the multi-stage injection realization load factor KLm, it is determined that the catalytic warm-up by the multi-stage injection can be continued, and this process is ended.

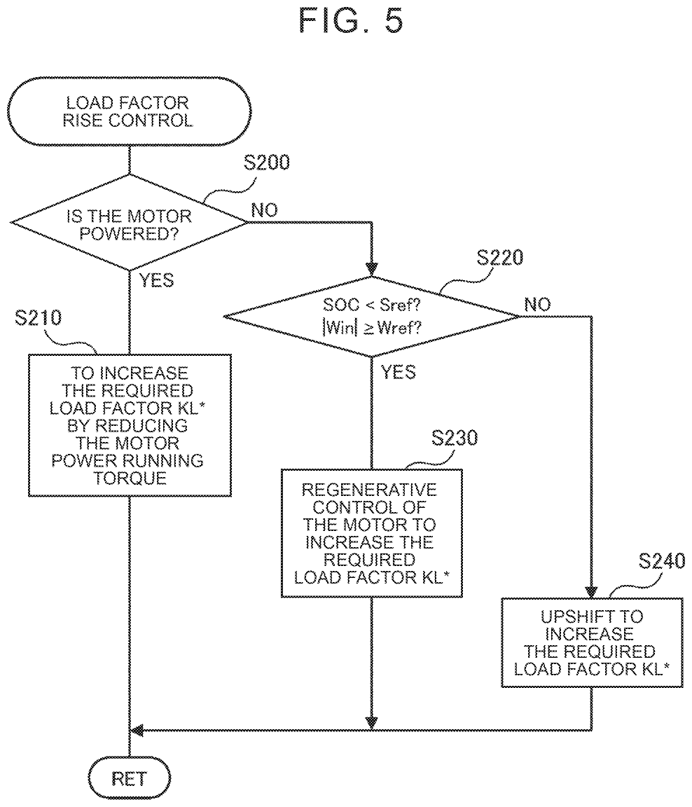

When it is determined in S110 that the required load factor KL* of the engine 22 is less than the multi-stage injection realization load factor KLm, a load factor increase control for increasing the load factor KL of the engine 22 is performed (S120), and this process is ended. An example of load factor increase control is shown in FIG. 5. FIG. 5 is a flow chart illustrating an exemplary load factor increase control executed by the engine ECU 24.

When the load factor increase control is executed, the engine ECU 24 first determines whether or not the motor 30 is subjected to the power running control (S200). Whether or not the motor 30 is subjected to the power running control can be determined by determining whether or not the torque command Tm* is a positive value (power running) or a negative value (regeneration). When it is determined that the motor 30 is subjected to the power running control, the required load factor KL* of the engine 22 is increased by decreasing the power running torque (torque command Tm*) of the motor 30 and increasing the target torque Te* required for the engine 22 (S210), and this process is ended. The amount of reduction in the power running torque of the motor 30 may be obtained as an amount in which the required load factor KL* becomes the multi-stage injection realization load factor KLm. The control of the motor 30 can be performed by switching the switching elements of the inverter 32 so that the reduced power running torque is transmitted as a torque command Tm* to HVECU 70 and the motor ECU 34, and the torque command Tm*, which is received by the motor ECU 34, is outputted from the motor 30. Control of the engine 22 at this time, the engine ECU 24 changes the target torque Te*of the engine 22 so as to match the reduction amount of the power running torque of the motor 30, and transmits it to HVECU 70 or the like, and controls the engine 22 so that the target torque Te*is output from the engine 22, that is, the required load factor KL*set so that the load factor KL of the engine 22 becomes equal to or higher than the multi-stage injection realization load factor KLm. By these controls, it is possible to continue the catalyst warm-up by the multi-stage injection even when the motor 30 is under the power running control.

In S200, when it is determined that the power running control of the motor 30 is not performed (the power running control is not performed or the power regeneration control is performed), it is determined whether or not the power storage ratio SOC of the high-voltage battery 60 is less than the threshold Sref and whether or not the absolute value of the input limit Win of the high-voltage battery 60 is equal to or greater than the threshold Wref (S220). When it is determined that the power storage ratio SOC of the high-voltage battery 60 is less than the threshold Sref and the absolute value of the input limit Win of the high-voltage battery 60 is equal to or greater than the threshold Wref, the motor 30 is regenerated using the torque command Tm* of the motor 30 as a negative value, and the required load factor KL* of the engine 22 is increased by increasing the target torque Te* required for the engine 22 (S230), and this process is ended. As the torque command Tm* of the motor 30, the required load factor KL* may be obtained as the multi-stage injection realization load factor KLm. The control of the motor 30 based on the torque command Tm* and the control of the engine 22 based on the target torque Te* at this time are the same as those in the case where it is determined that the motor 30 is under the power running control. By these controls, even when the motor 30 is not subjected to the power running control, when the power storage ratio SOC of the high-voltage battery 60 is less than the threshold Sref and the absolute value of the input limit Win of the high-voltage battery 60 is equal to or greater than the threshold Wref, the catalytic warm-up by the multi-stage injection can be continued.

When S220 determines that the power storage ratio SOC of the high-voltage battery 60 is equal to or greater than the threshold Sref or that the absolute value of the input limit Win of the high-voltage battery 60 is less than the threshold Wref, the speed of the automatic transmission 40 is upshifted to reduce the rotational speed Ne of the engine 22 to increase the required load factor KL* of the engine 22 (S240), and the process ends. The upshift can be performed by setting a shift stage at which the required load factor KL* of the engine 22 is equal to or greater than the multi-stage injection realization load factor KLm as the target shift stage M*, and controlling the automatic transmission 40 so that the shift stage M becomes the target shift stage M* by HVECU 70. The control of the engine 22 at this time obtains the target torque Te* required to output the required torque Tout* required to the output shaft 42 of the automatic transmission 40 at the rotational speed Ne of the engine 22 when the engine ECU 24 is set to the target transmission stage M*, and controls the engine 22 so that the target torque Te* is output from the engine 22, that is, the required load factor KL* set so that the load factor KL of the engine 22 becomes equal to or higher than the multi-stage injection realization load factor KLm. By these controls, the motor 30 is not subjected to power running control, and even when the power storage ratio SOC of the high-voltage battery 60 is equal to or greater than the threshold Sref or the absolute value of the input limit Win of the high-voltage battery 60 is less than the threshold Wref, the catalytic warm-up by the multi-stage injection can be continued.

In hybrid electric vehicle 20 of the embodiment described above, when the required load factor KL* of the engine 22 is less than the multi-stage injection realization load factor KLm during the execution of the catalyst warm-up control, the required load factor KL* is set to be equal to or greater than the multi-stage injection realization load factor KLm by performing the load factor increase control for increasing the load factor KL of the engine 22. Thus, it is possible to continue the catalyst warm-up by the multi-stage injection, and it is possible to suppress the deterioration of the emission during the catalyst warm-up.

Hybrid electric vehicle 20 of the embodiment includes an engine ECU 24, a motor ECU 34, and a HVECU 70. However, at least two of these may be integrally formed.

In the embodiment, the present disclosure is applied to hybrid electric vehicle configuration including the engine 22, the automatic transmission 40, and the motor 30, but the present disclosure may be applied to the configuration of an automobile including the engine and the automatic transmission without the motor.

Although the mode for carrying out the present disclosure has been described above with reference to the embodiment, an applicable embodiment of the present disclosure is not limited to the embodiment, and an applicable embodiment of the present disclosure may be carried out in various modes without departing from the gist of the present disclosure.

The present disclosure is applicable to the manufacturing industry of automobiles and the like.

What is claimed is:

1. An automobile comprising:
an engine that includes a catalyst device incorporating a catalyst for reducing exhaust gas in an exhaust system, and an in-cylinder injection valve;
an automatic transmission that changes a speed of power from the engine and outputs the power to a drive wheel side; and
a control device that performs a catalyst warm-up control for warming up the catalyst by performing a multi-stage injection and retarding an ignition timing, the multi-stage injection being a plurality of fuel injections from the in-cylinder injection valve, wherein the control device executes a load factor increase control such that a required load factor of the engine becomes equal to or higher than a multi-stage injection realization load factor at which the multi-stage injection is enabled during the catalyst warm-up control.

2. The automobile according to claim 1, wherein the load factor increase control is a control of increasing the required load factor by decreasing a rotational speed of the engine by upshifting a gear range of the automatic transmission.

3. The automobile according to claim 1, further comprising:
an electric motor that allows power to be input to and output from an input shaft or an output shaft of the automatic transmission; and
a power storage device that exchanges electric power with the electric motor, wherein the load factor increase control is a control of increasing the required load factor by controlling the electric motor.

4. The automobile according to claim 3, wherein the load factor increase control is a control of increasing the required load factor by reducing a power running output of the electric motor when the electric motor is under a power running control, and increasing the required load factor by regeneratively controlling the electric motor when the electric motor is not under the power running control.

5. The automobile according to claim 4, wherein the load factor increase control is a control of increasing the required load factor by regeneratively controlling the electric motor when the electric motor is not under the power running control and a power storage ratio of the power storage device is less than a predetermined ratio, and increasing the required load factor by decreasing a rotational speed of the engine by upshifting a gear range of the automatic transmission when the electric motor is not under the power running control and the power storage ratio of the power storage device is equal to or higher than the predetermined ratio.
